(19) United States
(12) Patent Application Publication
(10) Pub. No.: US 2010/0017815 A1
(43) Pub. Date: Jan. 21, 2010

(54) Method and Node in an IPTV Network

(76) Inventors: Ignacio Más Ivars, Tullinge (SE); George Philip Kongalath, Saint-Laurent (CA); Joacim Halén, Sollentuna (SE)

Correspondence Address: POTOMAC PATENT GROUP PLLC, P. O. BOX 270, FREDERICKSBURG, VA, 22404, US

(21) Appl. No.: 12/518,882

(22) PCT Filed: Dec. 20, 2006
(86) PCT No.: PCT/SE2006/050600

§ 371 Date: Sep. 11, 2009

(51) Int. Cl. H04H 60/32

(52) U.S. Cl. 725/14; 725/109

(57) ABSTRACT

The present invention relates to a method and a node in an IETV network. The node according to the present invention is configured to use the knowledge of the user channel switching behavior in order to predict user channel switching and to make the channels predicted to be used available close to the STB of the user in advance of the anticipated channel switch.

### TECHNICAL FIELD

The present invention relates to an Internet Protocol TV (IPTV) network, in particular it relates to a node in the IPTV network and a method for zapping among different media channels provided by a media content distributor.

### BACKGROUND

Today there exist several technologies to bring a TV channel to a viewer in a home:
wireless analog broadcasts over satellite, or terrestrial networks analog broadcasts over coaxial cable networks,
wireless digital broadcasts over satellite, or terrestrial networks digital broadcasts over coaxial cable networks, and
digital multicast or unicast streams over an IP network, referred to as IPTV.

The user experiences channel changes differently depending on which technology that is being used.

In the case of analogue broadcasts all TV channels are always present and the demodulation commences instantaneously. I.e., a channel switch will be experienced as instantaneously by a viewer.

In the digital world, there are two main factors that influences the time it takes for a picture of a first channel to be displayed on the TV screen when switching from a second channel to the first channel. Firstly, the time it takes to have the media stream of the first channel present at the TV set and secondly, once it is present, the decoding time i.e. that time it takes to generate the first picture frame of the first channel. In the case of digital broadcasts the channels are always present so the time it takes to have the media stream of the first channel present at the TV set is almost zero but the picture frames are encoded in order to save space for storage and bandwidth for transport. The time it takes for decoding to generate the first picture frame of the first channel adds a significant delay, in the order of seconds, to the channel switching. The commonly used encoding scheme, MPEG-2, defined by the Moving Picture Experts Group illustrates this in a simple way. MPEG-2 encoding gives a stream consisting of three different kinds of encoded frames: I-frames that contains enough information to decode frames to a TV picture frame, B-frames and P-frames that only contains information on what is changed relative the previous frame. I.e. it is not possible to decode and to generate a TV picture frame starting from a B-frame or P-frame. A sequence of I-, B-, and P-frames is shown in FIG. 1. Thus, an I-frame is required in order to generate the picture frames and the time between two I-frames is somewhere between 1 and 5 seconds.

When TV channels are sent over an IP network using IP multicast streams (or unicast streams) both factors, i.e. the time it takes to have the media stream of the new channel present at the TV and the time it takes to generate the first picture frame of the new channel will contribute to the channel switching time (also referred to as channel zapping time). In order to save network bandwidth a TV channel will only be brought to the user at the time it is requested and it is digitally encoded which adds the switching time as described. However, as broadband links with IP network connectivity become more and more popular many operators want to offer their customers bundled services including TV sent over the IP network. Sending the TV signal over an IP network also opens up the possibility to have interactive and personalized TV. That is, viewers can take part of a TV show by, for example voting, or receive personalized content associated with the TV channel, for example, personalized offers related to an advertisement.

As explained above, the channel switching time in an IPTV network may take up to several seconds, which results in lack of user satisfaction. Thus the main problem with IPTV channel switching is the lack of user satisfaction due to the long switching delay, i.e. the time it takes from initiating the switch until the picture from the selected channel appears on the TV screen. The main contributors of this delay are, as described above, the time it takes to get the selected media stream to TV and the time it takes to generate the first picture frame (in the case of MPEG-2 encoding: the time it takes to get the next I-frame).

In order to further explain the drawbacks with prior art, the steps of changing from one IPTV channel to another are described, assuming that the channels are delivered as IP multicast streams:

First the IPTV network sends an IGMP leave message to the existing multicast session and an IGMP join message to the selected multicast session. The process of leaving the session adds a constant time to the delay. The IGMP join adds a time proportional to the number of aggregation layers the IGMP join has to traverse until it reaches a multicast router that provides the selected multicast stream.

Present solutions trying to alleviate the delay caused by the time it takes to get the selected media stream to TV are based on forced static multi-cast subscriptions to all content streams as close to the last mile interface as possible. This effectively has the feel of a broadcast solution as there is no guarantee that the subscription is going to be used and the pipe to the last subscription group is carrying overhead instead of payload.

Further, there are no known solutions addressing the delay caused by the encoding, e.g. the inter-frame delay in case of MPEG2.

### SUMMARY

Thus an object of the present invention is to reduce the channel switching time in an IPTV network.

The concept of the present invention is based on predicting the possible channels, the favorite channels at given times, that the end user will switch to at a given time. Based on this prediction, the predicted channels are subscribed to in advance of the anticipated switch.

Thus, according to a first aspect of the present invention a node in an IPTV network for distributing media via a channel from a media content distributor to a connectable set-top-box of a user receiving the distributed media is provided The node comprises means for retrieving information relating to the user channel zapping behaviour, a predictor configured to predict at least one channel to be selected by the user based on the retrieved information, an initiator configured to subscribe to the predicted channel(s), and a buffer configured to buffer the subscribed predicted channel(s) to enable fast channel switching.

According to a second aspect a method in an IPTV network for distributing media via a channel from a media content distributor to a connectable set-top-box of a user receiving the distributed media is provided. The method comprises the steps of retrieving information relating to the user channel zapping behaviour, predicting at least one channel to be selected by the user based on the retrieved information, subscribing to the predicted channel(s), and buffering the subscribed predicted channel(s) to enable fast channel switching.

By buffering the predicted channels, having each buffer preferably starting with the latest I-frame, it is possible to generate a picture frame almost immediately giving the user an impression of immediate channel switch. However, the user will now watch the channel reverse time-shifted by one I-Frame length, i.e. a few ms to a few seconds ago. According to one embodiment, means are provided for deciding when to drop B-frames or/and P-frames until said buffered channel fed from the buffer is in synchronization with the main feed and then to switch to the main feed.

In order to be able to switch back to the current channel if a new channel is selected, the buffer will begin caching the I-Frame cycles of the channel being watched in accordance with one embodiment.

An advantage with the present invention is that it allows end users to receive a perceived channel zapping equivalent to that of the analogue world for the end users favourite channel list

A further advantage with the present invention is that it allows for the dynamic joins and leaves at the last mile driver device, reducing the bandwidth normally consumed by static provisioning of the join commands.

A further advantage with an embodiment of the present invention is that the buffering of the at least one I-frame cycle solves the problem of I-frame synchronization on the mpeg decoder in the STB. On a channel zap, it provides the I-Frame, the key frame that the mpeg decoder requires for generating a picture to be displayed on the screen.

### BRIEF DESCRIPTION OF THE DRAWINGS

FIG. 1 illustrates schematically a sequence of I-, P- and B-frames of MEG-2 according to prior art.

FIG. 2 illustrates schematically an IPTV network wherein the node according to the present invention may be implemented.

FIG. 3a illustrates schematically a node according to the present invention.

FIG. 3b illustrates an embodiment of the present invention.

FIG. 4 illustrates schematically the buffer according to one embodiment of the present invention.

FIG. 5 illustrates a part of the buffer according to an embodiment of the present invention.

FIGS. 6 and 7 are flowcharts of the method according to an embodiment of the present invention.

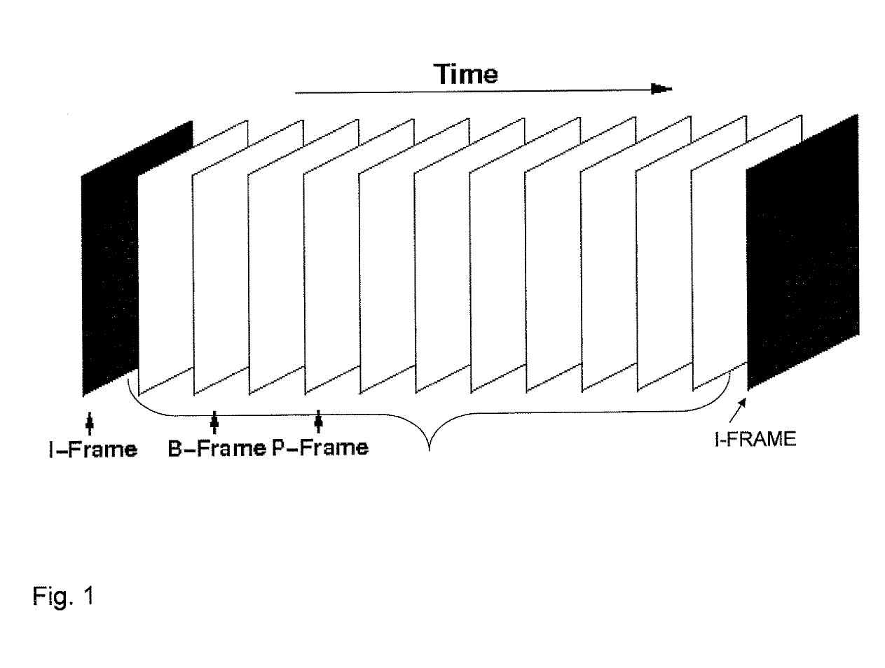

Still objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### DETAILED DESCRIPTION

The basic idea of the present invention is to utilize knowledge of the user channel switching behaviour and to create a channel switching prediction scheme. The node according to the present invention is configured to use the knowledge of the user channel switching behaviour in order to predict user channel switching and to make the channels predicted to be used available close to the STB of the user in advance of the anticipated channel switch.

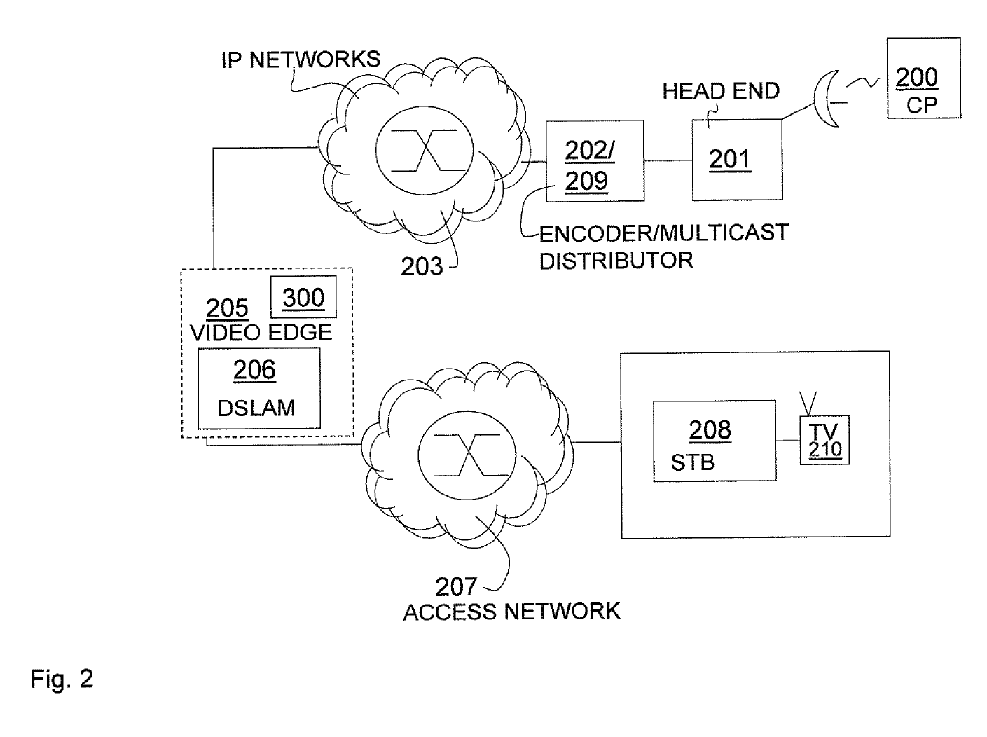

The node may be implemented in a video edge of an IPTV network as illustrated in FIG. 2. The IPTV network of FIG. 2 comprises a head end 201 connected to a content provider 200 and adapted to distribute a media stream comprising content from the content provider to an encoder 202 and multicast distributor 209. The encoder 202 encodes the media stream and the multicast distributor 209 distributes the encoded media by multicast distribution. The encoded media stream is multicasted via different IP-networks and routers 203 to a video edge 205 of the IPTV network. The video edge 205 is identified as the point where an end-user accesses the IP network. This is normally defined as the BRAS (Broadband remote access serve)/DSLAM combination. The normal edge only addresses the set-up of the data channel to the end-user. The video edge comprises a group of elements which adds functionality in this area which provides methods to improve the delivery of video services to the end user. Thus the video edge 205 comprises DSLAMs 206 (Digital Subscriber Line Access Multiplexers), and are further connected to an access network referred to as a last mile network 207. The last mile network is the network that connects the STB (set-top-box) of the user with the IP network, i.e. the link between the STB and the DSLAM. The last mile network 207 is further connected to a STB 208 of a user, whereby the STB 208 is connected to the TV set 210 of the user. The node 300 according to the present invention is preferably implemented in the video edge, but it can also be implemented in the DSLAM 206, or in the STB 208 or in the TV 210. The STB is a device that receives encrypted, non-encrypted multimedia and service signals and via an interface renders them on to the TV.

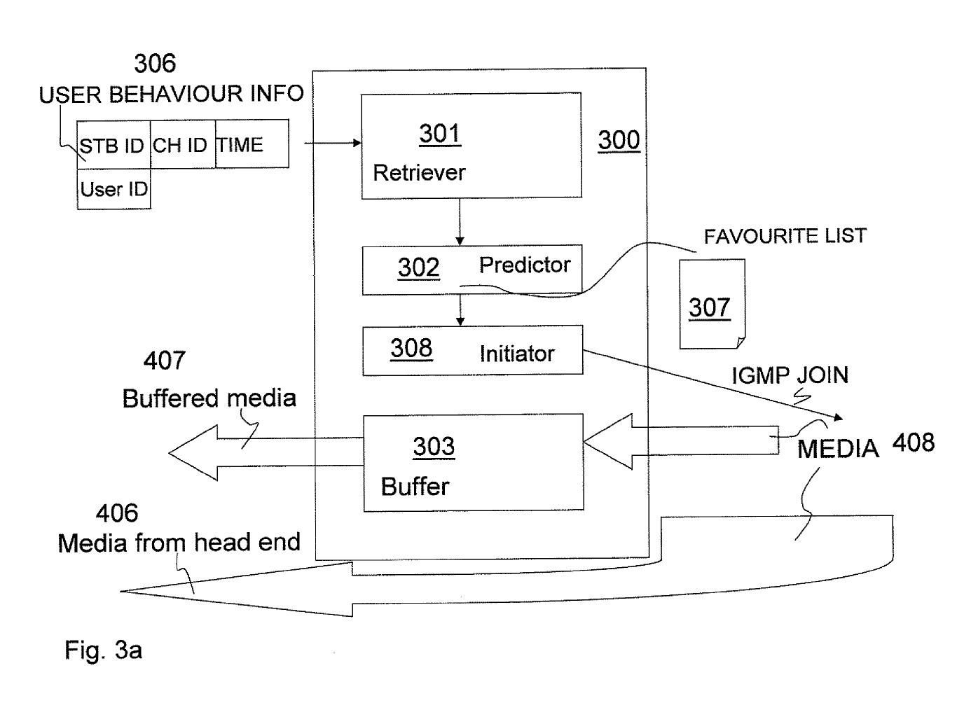

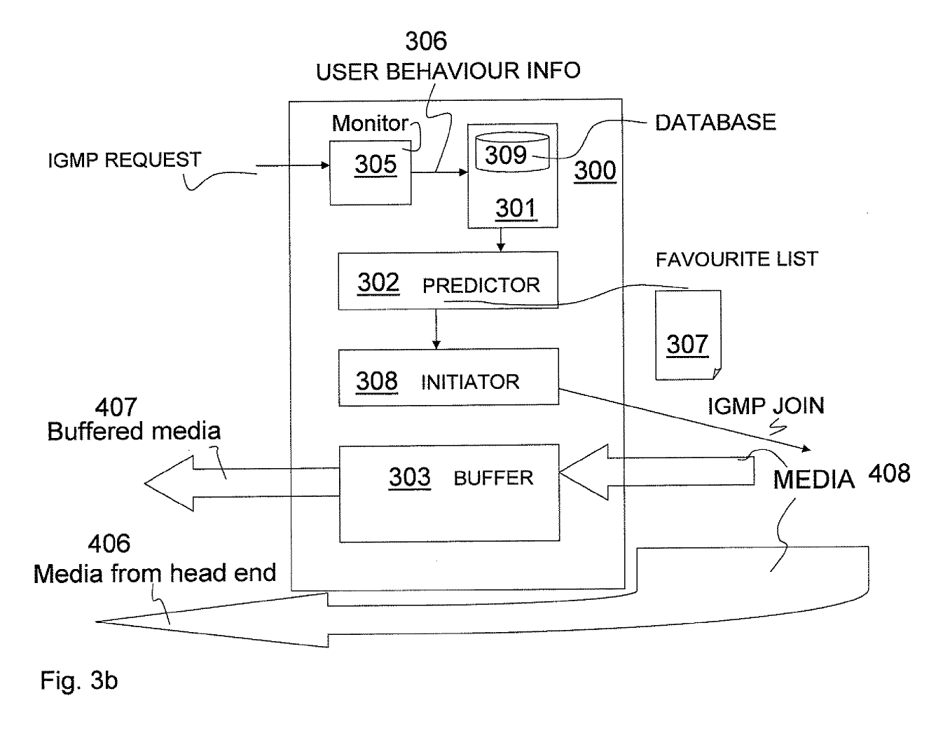

The present invention relates to a node in an IPTV network for distributing media or other content via a channel from a content provider 200 to a connectable set-top-box 208 of a user receiving the channel. The node 300 is illustrated in FIG. 3a and comprises a retriever 301 adapted to retrieve information 306 relating to the user channel zapping behaviour and a predictor 302 for predicting at least one channel to be selected by the user based on the retrieved information. Further, the node 300 comprises an initiator 308 adapted to subscribe to the predicted channel(s) and a buffer 303 for buffering the multicasted channel(s) to enable fast channel switching to the predicted channel(s). It should be noted that the initiator 308 initiates the buffering of the buffer 303.

The information relating to the channel zapping behaviour may comprise the time when the user performs a channel switching (i.e. performs the channel zapping) and also a property of the involved channels, e.g. if it is categorised as drama, sports, news, comedy etc. I.e. the information may comprise that user A changes from channel 1 to channel 3 at 8 pm on a Monday, wherein the current program on channel 1 was the sport news, e.g. categorised as sports, and the current program on channel 3 was an episode of “ER”, e.g. categorised as drama. Further the information relating to the user behaviour must also comprise the identity of the concerned STB. The identity of the specific user of the STB may also be included in the information. I.e. in a family of four members having one common STB may each member be identified and an individual channel zapping behaviour may be predicted for each of the family members.

Initially, each user is assigned a default user zapping behaviour. The user may update the default user zapping behaviour manually via graphical user interface (GUI). The user identity and channel identity are preferably recorded at a channel change which implies that the channel zapping behaviour may be updated periodically or on demand based on the channel zapping performed by the user,

Based on the information relating to the user channel zapping behaviour of an identified user, it is possible using proven data mining techniques to predict with a high degree of certainty the channels to which the identified user will switch to at any given time. Thus the node according to the present invention comprises a predictor adapted to predict at least one channel to be selected by the user in a near future based on the retrieved information relating to the channel zapping behaviour. Given an operator defined threshold for the probability to switch to a certain channel, it is possible to define a “favourite channel list” 307 comprising channels that will be selected by the user with a probability above the defined threshold. The “favourite channel list” is defined per user and dynamic with respect to time of day. The number of channels on the favourite list will be limited by the operator based on memory available in the buffer.

The channels defined in the “favourite channel list” 307 are according to the invention subscribed to and buffered in the buffer 303 to enable fast channel switching to the predicted channels. By storing the channels predicted to be selected by the user in the buffer, channels are already available for the STB of the user when the channel switching occurs. I.e. the delay caused of the time it takes to have the media stream of the channel at the STB of the user is substantially eliminated. It should be noted that the time it takes to transfer the media stream from the video edge, if the node of the present invention is implemented in the video edge, to the STB of the user is negligible compared to the total time of transferring the media stream from the head-end to the STB of the user. When the channels are buffered in the buffer, the channels are subscribed to and joined to the multicast group brought to the STB of the user. Thus, the initiator of the node is configured to subscribe to the channels that are predicted to be selected within a pre-determined time period, e.g. by issuing an IGMP join command. Then, if the user does not select any of the predicted channels, the node is configured to handle that a leave command is issued to free resources.

The buffer 303 is preferably configured to store the channels that are predicted to be used I-Frame to I-Frame of each channel, and also the channel being watched. By buffering the channel that is currently used it is possible to change back to that channel if the user selects another channel but regrets himself and wants to return to the previous channel. Hence the buffer is according to an embodiment adapted to buffer at least the latest I-frame cycle of each buffered media stream (channel).

The node may also comprise a monitor 305 adapted to monitor the channel zapping behaviour, e.g. by monitoring IGMP requests. The monitor is illustrated in FIG. 3b. The monitor 305 is hence adapted to record and create a log of the channel zapping behaviour and to provide user behaviour information 306 to the retriever 301. It should be noted that the monitor 305 may also be located separately from the node 300 of the present invention e.g. in a device in the last mile network.

Moreover, the node 300, e.g. the retriever 301, may also comprise a database 309 for storing the monitored channel behaviour, i.e. the created log. It should also be noted that the database may also be held in association with the monitor e.g. separately from the node as described above.

According to an embodiment, the node comprises a join facilitator adapted to feed one of the buffered media streams from the buffer to the set-top-box of the user. The buffering ensures that when the channel is zapped to, there is an instantaneous feed to which the STB can synchronize to and if the user zaps back there is no discontinuity.

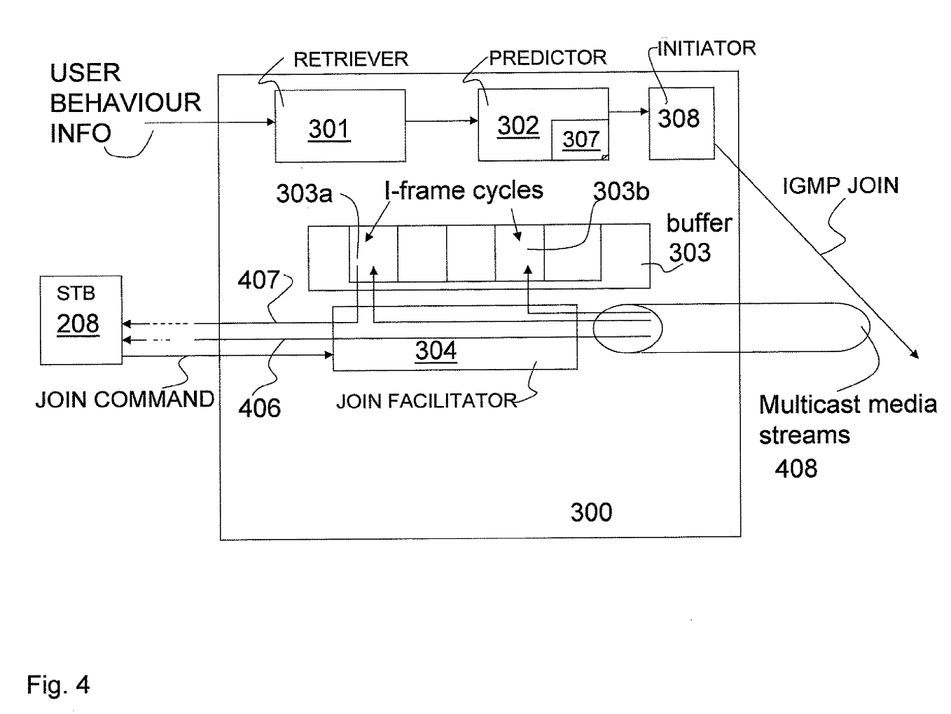

Alternatively, while the buffered channel is being fed to the STB, the buffer seeks out the next I-Frame on the channel in question and when it is located will feed the STB with the stream from the head-end. The node 300 comprising the buffer 303 and the join facilitator 304 is illustrated in FIG. 4. The media streams of the channels that are predicted by the predictor 302, based on the user behaviour information retrieved by the means for retrieving, to be used are fed from the content provider to the buffer 303. In this case, two channels are buffered I-frame to I-frame in 303a and 303b of the buffer 303. When one of the buffered channels are selected by the user (e.g. when a join command is issued), the join facilitator is adapted to feed the media stream 407 of the selected channel to the STB 208 of the user. It should be noted that the dotted line in FIG. 4 to the STB 208 indicates that intermediate nodes may be omitted.

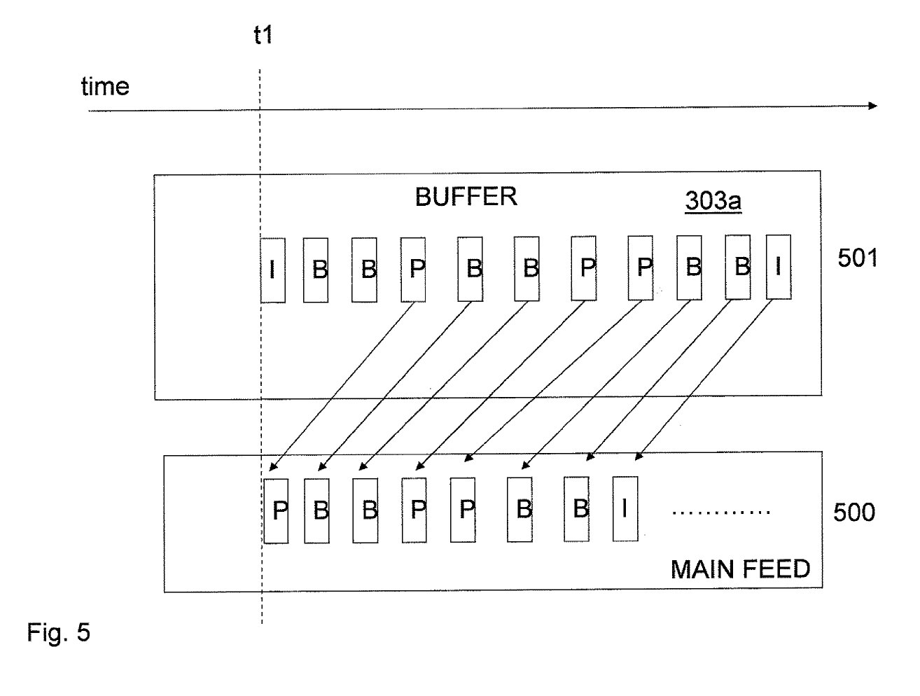

The invention also allows for the synchronization between the buffered channel and the channel when it is not buffered in the main feed as there is potential delay of the I-frame cycle time. The synchronization will occur by the dropping off b-frames and p-frames having a size below a configurable threshold. I.e. b-frames and p-frames containing a small amount of information (determined by the configurable threshold) are dropped. It should be noted that identification of p- and b-frames to be dropped may be performed by the buffer before the buffered media stream is fed to the STB of the user. The synchronization is illustrated by FIG. 5. FIG. 5 illustrates a media stream when buffered 501 in the buffer 303 (in this case the buffer part 303a of FIG. 4) and when fed directly from the main feed (the content provider). At time t1, the user switches to the buffered media stream. In order to be able to decode the stream, the transmission must start with tie first I-frame stored in the buffer. This is however not in the synchronization with the main feed, since the main feed is three frames ahead of the buffered stream. That implies that three frames of the B- and P-frames from the buffer has to be dropped in order to synchronize with the main feed.

Hence, the join facilitator is preferably adapted to monitor the buffer to be able to decide when to drop B-frames in accordance with the configurable threshold until said buffered media stream fed from the buffer is in synchronization with a corresponding media stream distributed directly from the media content distributor (referred to as the main feed).

Alternatively, the channel may be fed from the buffer during the entire time when the channel is viewed by the user. I.e. no synchronization is performed and the STB is only fed with the stream from the buffer and not from the main feed as in the embodiment above. If the STB is to be fed with the stream via the buffer, then it is recommended that two I-frame cycles are stored in the buffer.

Accordingly, based on the time required to join a channel, referred to as “m”, the node of the present invention is adapted to join the multicast groups as per the favourite channel list “n” seconds prior to the anticipated channel switch where “n” is the time required to join the groups plus a safety margin to ensure that the join has been accomplished m (n=m+safety margin) seconds in advance of the requested channel switch.

This invention also allows for the network engineers to predict the needs of the network as it can receive the favourite channel list for each user. The statistics may also provide marketing and business developers information of the channels that are being viewed and the channels that are not being viewed.

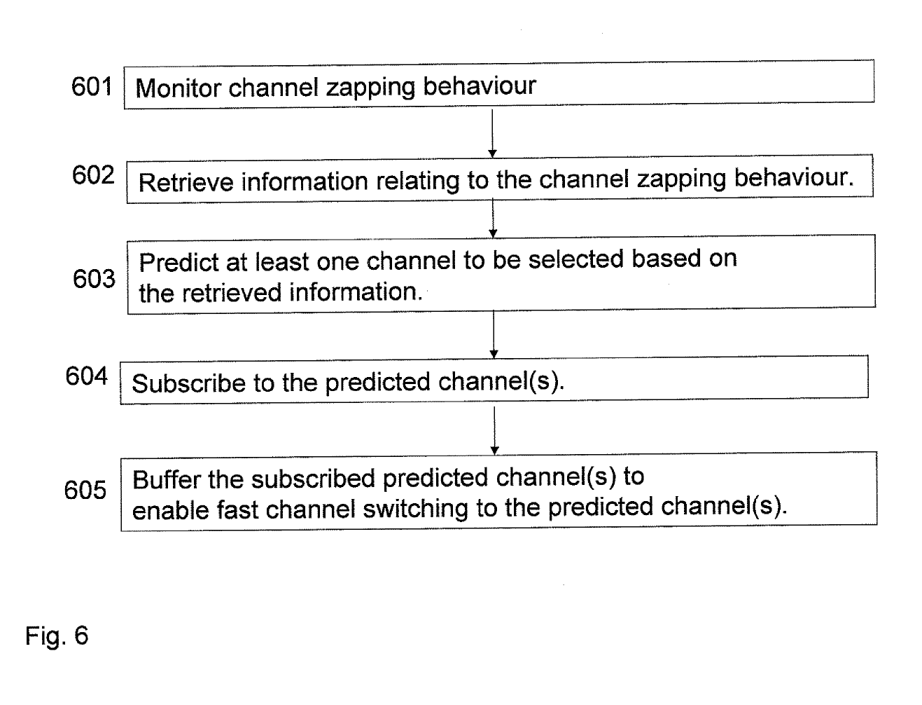

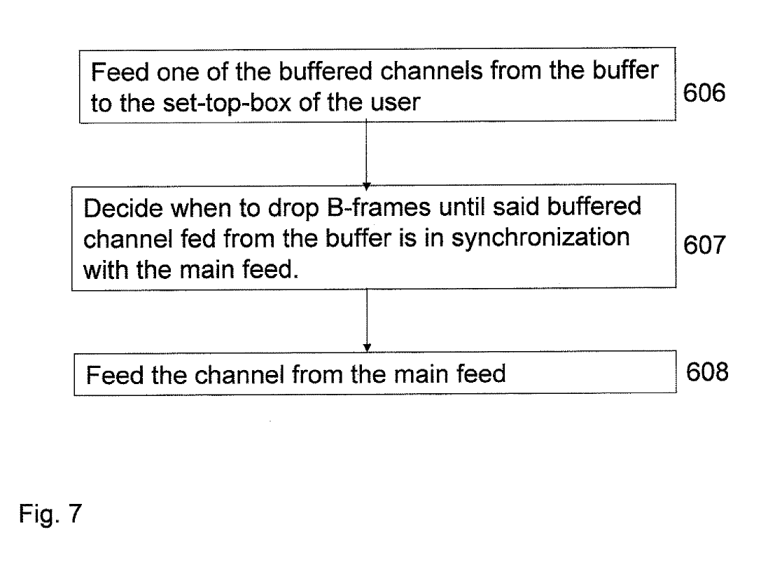

The present invention and embodiments thereof also relate to a method which will be described below in conjunction with FIG. 6.

601. Monitor the channel zapping behaviour.

602. Retrieve information relating to the channel zapping behaviour.

603. Predict at least one channel to be selected based on the retrieved information.

604. Subscribe to the predicted media stream(s).

605. Buffer the subscribed predicted media stream(s) to enable fast channel switching to the predicted media stream(s). According to an embodiment at least one I-frame cycle of the predicted media stream is buffered.

606. Feed one of the buffered channels from the buffer to the set-top-box of the user.

According to an alternative embodiment the following steps are also performed.

607. Monitor the buffer to decide when to drop B-frames or/and P-frames until said buffered channel fed from the buffer is in synchronization with a corresponding channel distributed directly from the media content provider. I.e. the corresponding channel that is not fed via the buffer, which is also referred to as the main feed.

608. Feed the channel from the main feed.

Hence, when the STB of the user issues a channel switching command to a channel that is predicted to be used, the node according to an embodiment is configured to execute the following steps:

Stop the feed of the channel being viewed and begins the feed of the buffered channel I-frame to I-frame.

Feed the buffered I-Frame to I-Frame to the STB of the user.

Start inspecting the B-frames and P-frames to determine which frames can be dropped according to the configurable threshold.

When the next I-Frame of the buffered channel is detected a non-seamless switch may be performed or a seamless switch may be performed.

The non-seamless switch implies that the stream to the STB is switched from the buffered feed to that of the main feed. This will cause a loss of data that describes the time between the buffered playout and the switch point in the main stream. This will lead to an abrupt transition between scenes and will be noticed by the end user.

The seamless switch implies that b- and p-frames are dropped based on the threshold as described above until the buffered media stream is in synchronization with the media stream of the main feed. When synchronization is achieved, the media stream from the main feed is fed to the STB of the user. This method ensures perceived smoothness of the video and improves end user satisfaction

If the user decides to zap back to the channel being previously viewed, the buffered media stream of the channel being previously viewed is fed and the process of synchronizing repeated.

While the invention has been described in terms several embodiments, it is contemplated that alternatives, modifications, permutations and equivalents thereof will become apparent to those skilled in the art upon reading of the specifications and study of the drawings. It is therefore intended that the following appended claims include such alternatives, modifications, permutations and equivalents as fall within the scope of the present invention.

1. A node in an IPTV network for distributing media via a channel from a media content distributor to a connectable set-top-box of a user receiving the distributed media, comprising:
means for retrieving information relating to the user channel zapping behaviour;
a predictor configured to predict at least one channel to be selected by the user based on the retrieved information;
an initiator configured to subscribe to the predicted channel(s), and a buffer configured to buffer the subscribed predicted channel(s) to enable fast channel switching; and
a join facilitator adapted to feed one of the buffered channels that is selected by the user from the buffer to the set-top-box of the user and to drop B-frames or/and P-frames until said buffered channel fed from the buffer is in synchronization with a corresponding channel distributed directly from the media content provider.

2. The node according to claim 1, wherein the buffer is further adapted to store the channel that is currently being viewed.

3. The node according to claim 1, wherein the information relating to the channel zapping behaviour comprises the time of a channel zapping and at least one property of the zapped channels.

4. The node according to claim 1, comprising a monitor configured to monitor the channel zapping behaviour and configured to provide the retriever the information relating to the user channel zapping behaviour.

5. The node according to claim 1, comprising a database for storing the retrieved user behaviour information.

6. The node according to claim 1, wherein the buffer is adapted to buffer at least the latest I-frame cycle of the at least one buffered channel.

7. (canceled)

8. (canceled)

9. The node according to claim 1, wherein the node is implemented in a video edge.

10. The node according to claim 1, wherein the channel comprises media.

11. A method in an IPTV network for distributing media via a channel from a media content distributor to a connectable set-top-box of a user receiving the distributed media, comprising the steps of:
retrieving information relating to the user channel zapping behaviour, predicting at least one channel to be selected by the user based on the retrieved information;
subscribing to the predicted channel(s);
buffering the subscribed predicted channel(s) to enable fast channel switching;
feeding one of the buffered channels from the buffer to the set-top-box of the user that is selected by the user; and
deciding when to drop B-frames and/or P-frames until said buffered channel fed from the buffer is in synchronization with a corresponding channel distributed directly from the media content provider.

12. The method according to claim 11, wherein the buffering step also comprises buffering the channel that is currently being viewed.

13. The method according to claim 11, comprising the step of monitoring the channel zapping behaviour.

14. The method according to claim 11, wherein the buffering step comprises buffering at least the latest I-frame cycle of the at least one buffered channel.

15. (canceled)

16. (canceled)

17. The method according to claim 14, further comprising the step of feeding a channel from the main feed wherein the channel corresponds to said buffered channel.
